(19) United States
(12) Patent Application Publication
(10) Pub. No.: US 2025/0214888 A1
(43) Pub. Date: Jul. 3, 2025

(54) VEHICLE GLASS HAVING A THREE-DIMENSIONAL PATTERN

(71) Applicants: HYUNDAI MOTOR COMPANY, Seoul (KR); KIA CORPORATION, Seoul (KR); KCC GLASS CORPORATION, Seoul (KR)

(72) Inventors: Nak Kyoung Kong, Seongnam-si (KR); Kyung Hwan Kim, Seoul (KR); Sang Heon Wang, Hwaseong-si (KR); Dae Hee Lee, Incheon (KR); Yeong Mi Kim, Sejong-si (KR); Jun Ho Bang, Cheonan-si (KR); Kuk Bum Lee, Sejong-si (KR)

(73) Assignees: HYUNDAI MOTOR COMPANY, Seoul (KR); KIA CORPORATION, Seoul (KR); KCC GLASS CORPORATION, Seoul (KR)

(21) Appl. No.: 18/902,249

(22) Filed: Sep. 30, 2024

(30) Foreign Application Priority Data
Jan. 2, 2024 (KR) 10-2024-0000345

(51) Int. Cl. C03C 17/36

(52) U.S. Cl. CPC C03C 17/3605; C03C 17/3626; C03C 2217/26; C03C 2217/281; C03C 2218/119

(57) ABSTRACT

Vehicle glass has a three-dimensional pattern and includes a pattern layer printed on a glass substrate to implement a plurality of shaded portions. The vehicle glass also has a metallic coating layer stacked on the pattern layer to be exposed from the glass substrate through the shaded portions. The pattern layer is divided into a first region and a second region to implement the shaded portions. The pattern layer realizes a difference in shade between the first region and the second region.

### CROSS REFERENCE TO RELATED APPLICATION

The present application claims priority to Korean Patent Application No. 10-2024-0000345, filed Jan. 2, 2024, the entire contents of which are incorporated herein for all purposes by this reference.

### BACKGROUND

### Field of the Disclosure

The present disclosure relates generally to vehicle glass having a three-dimensional pattern. More particularly, the present disclosure relates to vehicle glass in which a three-dimensional pattern can be applied to a glass substrate through the implementation of a translucent surface.

### Description of the Related Art

In general, coating technology applied to vehicle glass has been used for various purposes and functions such as infrared reflection, anti-glare, anti-reflection, water repellency, and front heat generation. However, the demand for adding aesthetic elements in addition to adding vehicle glass functions is rapidly increasing.

To this end, various methods of adding aesthetic elements to vehicle glass have been developed. These methods include attaching a colored film to an inner side of glass by a consumer or inserting a colored film between glass and then bonding them together.

However, the process of attaching the colored film to the inner side of the glass is an additional process performed after the vehicle is shipped, so it may cause inconvenience to consumers. In addition, the technology of inserting and bonding the colored film uses thicker glass compared to tempered glass. Thus, it may increase fuel consumption due to increased vehicle weight, resulting in reduced fuel efficiency and fuel mileage.

In an effort to solve the above problems and add aesthetic elements to the vehicle glass, a method of adding a coating process to vehicle glass manufacturing process has been proposed.

However, when the coating process is added to the vehicle glass manufacturing process, problems arise such as imbalance of coated glass, coating damage due to high temperature heat, decrease in aesthetic elements, and reduced fixation efficiency. Also, there is a disadvantage in that the coating can only be applied to either a laminated glass or tempered glass process.

In addition, in order to add design elements to vehicle glass composed of conventional tempered glass and laminated glass, there is a disadvantage in that durability (reliability) and robustness have to be sufficient to prevent the design elements from being damaged by external shocks or environmental factors.

The foregoing is intended merely to aid in understanding the background of the present disclosure. The foregoing not intended to mean that the present disclosure falls within the purview of the related art that is already known to those having ordinary skill in the art.

### SUMMARY

Accordingly, the present disclosure has been made keeping in mind the above problems occurring in the related art. An objective of the present disclosure is to provide vehicle glass having a three-dimensional pattern. A shading of a pattern layer is realized by adjusting intervals of dot-shaped block enamels. A metallic coating layer is stacked on the pattern layer so that the luster of the metallic coating layer is exposed in the form of a three-dimensional pattern outside the vehicle, depending on the shading level of the pattern layer. A non-metallic protective layer is coated on the metallic coating layer to protect the metallic coating layer from corrosion and scratches. Both the metallic coating layer and non-metallic protective layer are implemented in a translucent form. This realizes design differentiation through exposure of a three-dimensional pattern, while ensuring visibility for passengers through implementation of a translucent surface and giving them a sense of openness.

In order to achieve the above objectives, according to one aspect of the present disclosure, vehicle glass is provided having a three-dimensional pattern. The vehicle glass includes a pattern layer printed on a glass substrate and formed to implement a plurality of shaded portions and a metallic coating layer stacked on the pattern layer and formed to be exposed from the glass substrate through the shaded portions. The pattern layer may be divided into a first region and a second region to implement the shaded portions. The pattern layer may be formed such that a difference in shade is realized between the first region and the second region.

Here, the pattern layer may be formed by printing a plurality of dot-shaped black enamels for a shade difference on the glass substrate and by adjusting printing intervals of the black enamels to realize the difference in shade between the first region and the second region.

The pattern layer may be formed by printing so that dot intervals of the black enamels in the first region are wider than dot intervals of the black enamels in the second region. Thus, the first region may be implemented in a relatively brighter shade than the second region.

In an embodiment, the metallic coating layer may be a translucent metallic coating layer made from any one of chromium (Cr), aluminum (Al), copper (Cu), nickel (Ni), silver (Ag), gold (Au), palladium (Pd), or any combination thereof.

In an embodiment, the metallic coating layer may have a thickness of 10 to 50 nanometers (nm).

In addition, the vehicle glass may further include a non-metallic protective layer stacked on the metallic coating layer and protecting the metallic coating layer.

In an embodiment, the non-metallic protective layer may have a thickness of 30 to 40 nm.

Here, the non-metallic protective layer may be a translucent non-metallic protective layer made from silicon nitride or Si₃N₄.

Meanwhile, according to another aspect of the present disclosure, vehicle glass is provided having a three-dimensional pattern. The vehicle glass includes a metallic coating layer stacked on a glass substrate and a pattern layer printed on the metallic coating layer. The pattern layer is formed to implement a plurality of shaded portions and is formed through the metallic coating layer to expose the shaded portions from the glass substrate. The pattern layer may be divided into a first region and a second region to implement the shaded portions. The pattern layer may be formed such that a difference in shade is realized between the first region and the second region.

The pattern layer may be formed by printing a plurality of dot-shaped black enamels for a shade difference on the glass substrate and by adjusting printing intervals of the black enamels to realize the difference in shade between the first region and the second region.

In addition, the pattern layer may be formed by printing so that dot intervals of the black enamels in the first region are wider than dot intervals of the black enamels in the second region. Thus, the first region may be implemented in a relatively brighter shade than the second region.

In an embodiment, the metallic coating layer may be a translucent metallic coating layer made from any one of Cr, Al, Cu, Ni, Ag, Au, and Pd.

In addition, the vehicle glass may further include a non-metallic protective layer protecting the metallic coating layer. The non-metallic protective layer may be stacked on the metallic coating layer including the pattern layer in a state in which the pattern layer is printed on the metallic coating layer.

In addition, the vehicle glass may further include a non-metallic protective layer protecting the metallic coating layer. The pattern layer may be printed on the non-metallic protective layer in a state in which the non-metallic protective layer is stacked on the metallic coating layer.

According to the present disclosure, by realizing shading of the pattern layer by adjusting the intervals of the dot-shaped block enamels and by stacking the metallic coating layer on the pattern layer, the luster of the metallic coating layer can be exposed in the form of a three-dimensional pattern outside the vehicle, depending on the shading level of the pattern layer. Design differentiation is thereby realized through exposure of a three-dimensional pattern.

In addition, by coating the non-metallic protective layer to protect the metallic coating layer from corrosion and scratches on the metallic coating layer and by implementing both the metallic coating layer and the non-metallic protective layer in a translucent form, it is possible to ensure visibility for occupants and give them a sense of openness.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a view illustrating vehicle glass having a three-dimensional pattern according to an embodiment of the present disclosure;

FIG. 2 is a sectional view taken along line A-A of the vehicle glass of FIG. 1 and illustrating the structure of a glass substrate in the vehicle glass having the three-dimensional pattern according to an embodiment of the present disclosure;

FIG. 3 is a view illustrating surface processing performed on the vehicle glass having the three-dimensional pattern according to an embodiment of the present disclosure;

FIG. 4 is a sectional view taken along line A-A of the vehicle glass of FIG. 1 and illustrating the structure of a glass substrate according to a first embodiment of vehicle glass having a three-dimensional pattern according to the present disclosure;

FIG. 5 is a view illustrating surface processing according to a first embodiment performed on vehicle glass having the three-dimensional pattern according to an embodiment of the present disclosure;

FIG. 6 is a sectional view taken along line A-A of the vehicle glass of FIG. 1 and illustrating the structure of a glass substrate according to a second embodiment of vehicle glass having the three-dimensional pattern according to the present disclosure; and

FIG. 7 is a view illustrating surface processing according to a second embodiment performed on vehicle glass having the three-dimensional pattern according to an embodiment of the present disclosure.

### DETAILED DESCRIPTION

Hereinbelow, by way of example, embodiments of the present disclosure are described in detail with reference to the accompanying drawings.

The present disclosure, advantages of the present disclosure, and objectives achieved by the present disclosure should become more apparent from the following detailed description of embodiments in conjunction with the accompanying drawings.

It should be understood that the present disclosure is not limited to the following embodiments and may be embodied in different ways, and that the embodiments are given to provide complete disclosure of the technical concepts of the present disclosure and to provide a thorough understanding of the present disclosure to those having ordinary skill in the art. The scope of the present disclosure is defined only by the claims.

Further, in the following description of the present disclosure, a detailed description of related known configurations or functions may have been omitted to avoid obscuring the subject matter of the present disclosure. When a component, device, element, or the like of the present disclosure is described as having a purpose or performing an operation, function, or the like, the component, device, or element should be considered herein as being “configured to” meet that purpose or perform that operation or function.

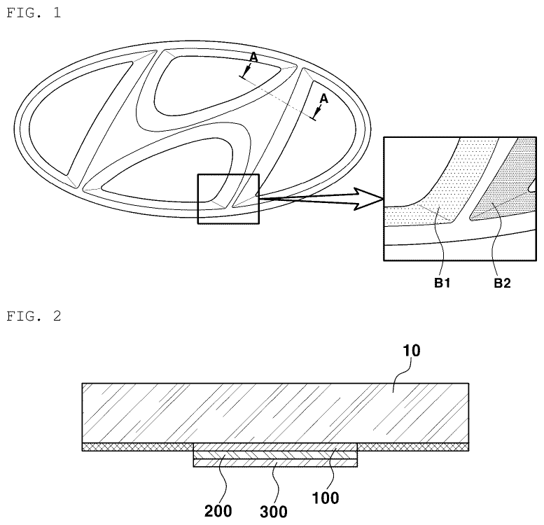

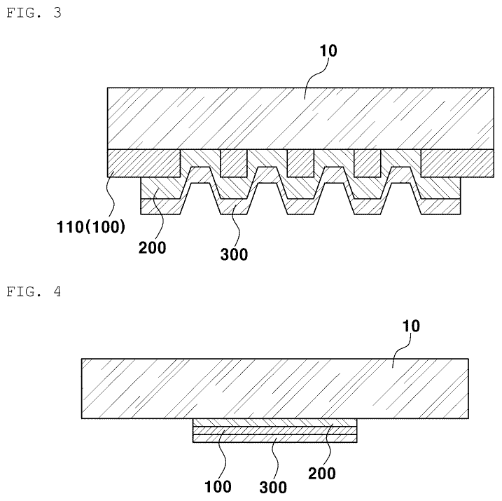

FIG. 1 is a view illustrating vehicle glass having a three-dimensional pattern according to an embodiment of the present disclosure. FIG. 2 is a sectional view taken along line A-A of FIG. 1 and illustrates the structure of a glass substrate in the vehicle glass having the three-dimensional pattern according to an embodiment of the present disclosure. FIG. 3 is a view illustrating surface processing performed on the vehicle glass having the three-dimensional pattern according to an embodiment of the present disclosure.

Generally, it is difficult to implement a three-dimensional pattern using only surface processing on a glass substrate due to limitations in color and contrast expression.

As illustrated in FIG. 1, in order to provide vehicle glass having a three-dimensional pattern in which shading such as the “H” corporate logo is expressed, in this embodiment, as illustrated in FIG. 2, a pattern layer 100 and a metallic coating layer 200 may be sequentially stacked on a glass substrate 10.

The pattern layer 100 is printed on the glass substrate of a single plate structure and is formed to implement a plurality of shaded portions with shade differences, as illustrated in the enlarged part of FIG. 1.

In other words, the pattern layer 100 is divided into a first region B1 and a second region B2 to implement shaded portions with a three-dimensional pattern. A difference in shade is realized between the first region B1 and the second region B2.

Here, dividing the first region B1 and the second region B2 for implementing the shaded portions is only an example to explain the difference in shade. The present disclosure is not limited to two regions with relative difference in shade but include more regions such as a third region and a fourth region to realize a shade difference.

In an embodiment, the pattern layer 100 is formed by printing a plurality of dot-shaped black enamels 110 for a shade difference on the glass substrate 10. The pattern layer 100 is also formed by adjusting printing intervals of the black enamels 110 to realize a difference in shade between the first region B1 and the second region B2.

In an embodiment, as illustrated in the enlarged part of FIG. 1, in order to implement a three-dimensional pattern, the pattern layer 100 is formed by printing so that dot intervals of the black enamels 110 in the second region B2 are 0.1 mm and dot intervals of the black enamels 110 in the first region B1 are 0.3 nanometers (mm). By adjusting the dot intervals, the first region B1 can be implemented in a relatively brighter shade than the second region B2, thereby making it possible to implement a three-dimensional pattern in which inclined surfaces are formed around the “H” logo.

The pattern layer 100 may be formed by printing a plurality of black enamels 110 with shapes other than the dot shape on the glass substrate 10 to implement a three-dimensional pattern. In addition, a three-dimensional pattern may be implemented, not through the intervals between the black enamels 110, but through a difference in density of the black enamels 110 per the same printing area.

The metallic coating layer 200 is stacked on the pattern layer 100 and is formed to be exposed from the glass substrate through portions between the dots of the plurality of black enamels 110.

The metallic coating layer 200 is applied to a front side of the glass substrate 10 according to the shade level of the black enamels 110 printed on the pattern layer 100, i.e., so that the luster of metal is visible from the outside of the vehicle.

In an embodiment, the metallic coating layer 200 is formed by stacking a metallic luster layer, which is made from a chromium (Cr) material by sputtering, on the pattern layer 100, so that the luster of metal is visible from the outside of the vehicle.

In an embodiment, the material from which the metallic coating layer 200 is formed by sputtering includes any one of aluminum (Al), copper (Cu), nickel (Ni), silver (Ag), gold (Au), or palladium (Pd), in addition to chromium (Cr), or any combination thereof.

As illustrated in FIG. 3, the metallic coating layer 200 may be formed so that a translucent surface, which allows the outside of the glass substrate 10 to be visible from the interior of the vehicle, is implemented through the dot intervals of the black enamels 110. For this purpose, the metallic coating layer 200 may be formed to have a thickness of 10 to 50 nm, which allows some light to be transmitted.

Meanwhile, as illustrated in FIGS. 2 and 3, the vehicle glass having the three-dimensional pattern according to this embodiment may further include a non-metallic protective layer 300 stacked on the metallic coating layer 200 and protecting the metallic coating layer 200.

The non-metallic protective layer 300 is stacked on the metallic coating layer 200 to protect the metallic coating layer 200 from corrosion and scratches. In an embodiment, the non-metallic protective layer 300 may be a transparent non-metallic protective layer made from silicon nitride (Si₃N₄) by sputtering to prevent oxidation and scratches of the metallic coating layer 200.

Since the non-metallic protective layer 300 is implemented as a transparent non-metallic protective layer, when it is stacked on the translucent metallic coating layer 200 as described above, it is possible to implement a translucent surface that allows the exterior of the vehicle to be visible from the interior of the vehicle. This can ensure high marketability and visibility for in-vehicle occupants.

For example, in the cross-section A-A of FIG. 1, a pattern layer 100, a metallic coating layer 200 with a thickness of 10 to 50 nm for implementing translucency, and a transparent non-metallic protective layer 300 with a thickness of 30 to 40 nm are applied to glass substrate 10 with a thickness of 3 t. In the case of a combination of the thick metallic coating layer 200 and the non-metallic protective layer 300 (50 nm+40 nm), it has a relatively low visible light transmittance. In the case of a combination of the thin metallic coating layer 200 and the non-metallic protective layer 300 (10 nm+30 nm), it has a relatively high visible light transmittance. Although there is a difference in the visible light transmittance in the both cases, predetermined visible light transmittance is achieved. Thus, it is possible to implement a translucent surface that allows the exterior of the vehicle to be visible from the interior of the vehicle.

Based on the above configuration, the processes of manufacturing the vehicle glass with the three-dimensional pattern according to this embodiment are sequentially described as follows.

First, a pattern layer 100 including a plurality of black enamels 110 is printed on glass substrate 10 of a single plate structure. Then processes of drying, heating, cooling, and washing are performed to implement shaded portions with a three-dimensional pattern on the glass substrate 10.

Here, when forming the pattern layer 100 by printing dot-shaped black enamels 110, the pattern layer 100 is divided into a first region B1 and a second region B2 to implement shaded portions with a three-dimensional pattern. The pattern layer 100 is formed such that a difference in shade is realized between the first region B1 and the second region B2 (see FIG. 1)

After that, the remaining region except for the pattern layer 100 is masked and a metallic coating layer 200 and a non-metallic protective layer 300 are sequentially implemented on the pattern layer 100 by sputtering (see FIG. 2). Processes of drying, molding/strengthening, and washing/drying are performed to finally manufacture glass substrate 10 with a three-dimensional pattern in which a shade difference is realized (see FIG. 3).

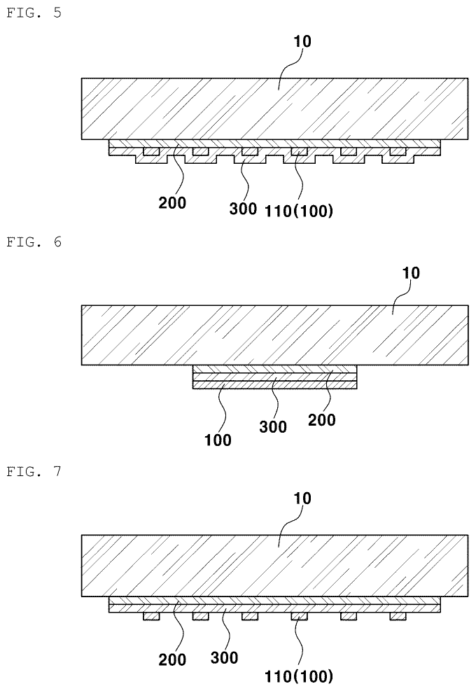

Meanwhile, FIG. 4 is a sectional view taken along line A-A of FIG. 1. FIG. 4 illustrates the structure of a glass substrate according to a first embodiment of vehicle glass having a three-dimensional pattern according to the present disclosure. FIG. 5 is a view illustrating surface processing according to the first embodiment performed on the vehicle glass having the three-dimensional pattern according to the present disclosure.

In addition, FIG. 6 is a sectional view taken along line A-A of FIG. 1. FIG. 6 illustrates the structure of a glass substrate according to a second embodiment in the vehicle glass having the three-dimensional pattern according to the present disclosure. FIG. 7 is a view illustrating surface processing according to the second embodiment performed on the vehicle glass having the three-dimensional pattern according to the present disclosure.

As illustrated in FIG. 4, the vehicle glass having the three-dimensional pattern according to this embodiment may be formed by sequentially stacking a metallic coating layer 200 and a pattern layer 100 on a glass substrate 10.

More specifically, the vehicle glass having the three-dimensional pattern according to this embodiment may include the metallic coating layer 200 stacked on the glass substrate 10 and may include the pattern layer 100 printed on the metallic coating layer 200, formed to implement a plurality of shaded portions, and formed through the metallic coating layer 200 to expose the shaded portions from the glass substrate 10.

Here, the metallic coating layer 200 and the pattern layer 200 sequentially stacked on the glass substrate 10 are the same as those in the above-described embodiment. Thus, detailed descriptions thereof have been omitted.

In addition, like the above-described embodiment, the vehicle glass having the three-dimensional pattern according to this embodiment may further include a non-metallic protective layer 300 protecting the metallic coating layer 200. As illustrated in FIG. 5, in a state in which the pattern layer 100 is printed on the metallic coating layer 200, the non-metallic protective layer 300 may be stacked on the metallic coating layer 200 including the pattern layer 100 to surround a plurality of black enamels 110.

The order for implementing the surface treatment for the glass substrate 10 is only an example. The order may be selectively changed and thus is not intended to be fixed. For example, as illustrated in FIGS. 6 and 7, in a state in which the non-metallic protective layer 300 is stacked on the metallic coating layer 200, the pattern layer 100 may be printed on the non-metallic protective layer 300.

Like the above-described embodiment, the metallic coating layer 200 according to this embodiment implements a translucent surface and the non-metallic protective layer 300 is implemented as a transparent non-metallic protective layer. With the implementation of the translucent surface that allows the exterior of the vehicle to be visible from the interior of the vehicle, it is possible to ensure high marketability and visibility for interior occupants.

According to the present disclosure, by realizing shading of the pattern layer by adjusting the intervals of the dot-shaped block enamels and by stacking the metallic coating layer on the pattern layer, the luster of the metallic coating layer can be exposed in the form of a three-dimensional pattern outside the vehicle, depending on the shading level of the pattern layer. Design differentiation may thereby be realized through exposure of a three-dimensional pattern.

In addition, by coating the non-metallic protective layer to protect the metallic coating layer from corrosion and scratches on the metallic coating layer and by implementing both the metallic coating layer and the non-metallic protective layer in a translucent form, it is possible to ensure visibility for occupants and give them a sense of openness.

Although various embodiments of the present disclosure have been disclosed for illustrative purposes, those having ordinary skill in the art should appreciate that various modifications, additions, and substitutions are possible, without departing from the scope and spirit of the present disclosure. It is thus well known to those of ordinary skill in that art that the patent right of the present disclosure should be defined by the scope and spirit of the present disclosure as set forth in the accompanying claims.

What is claimed is:

1. Vehicle glass having a three-dimensional pattern, the vehicle glass comprising:
a pattern layer printed on a glass substrate to implement a plurality of shaded portions; and
a metallic coating layer stacked on the pattern layer to be exposed from the glass substrate through the shaded portions,
wherein the pattern layer is divided into a first region and a second region to implement the shaded portions, and
wherein the pattern layer realizes a difference in shade between the first region and the second region.

2. The vehicle glass of claim 1, wherein the pattern layer is formed by printing a plurality of black enamels having a dot shape for a shade difference on the glass substrate and wherein adjusting printing intervals of the plurality of black enamels to realize the difference in shade between the first region and the second region.

3. The vehicle glass of claim 2, wherein the pattern layer is formed by printing so that dot intervals of the plurality of black enamels in the first region are wider than dot intervals of the plurality of black enamels in the second region, whereby the first region is implemented in a relatively brighter shade than the second region.

4. The vehicle glass of claim 1, wherein the metallic coating layer is a translucent metallic coating layer made from any one of chromium (Cr), aluminum (Al), copper (Cu), nickel (Ni), silver (Ag), gold (Au), palladium (Pd), or any combination thereof.

5. The vehicle glass of claim 1, wherein the metallic coating layer has a thickness of 10 to 50 nanometers (nm).

6. The vehicle glass of claim 1, further comprising:
a non-metallic protective layer stacked on the metallic coating layer and protecting the metallic coating layer.

7. The vehicle lass of claim 6, wherein the non-metallic protective layer is a translucent non-metallic protective layer made from silicon nitride (Si₃N₄).

8. The vehicle glass of claim 6, wherein the non-metallic protective layer has a thickness of 30 to 40 nm.

9. Vehicle glass having a three-dimensional pattern, the vehicle glass comprising:
a metallic coating layer stacked on a glass substrate; and
a pattern layer printed on the metallic coating layer, implementing a plurality of shaded portions, and provided through the metallic coating layer to expose the shaded portions from the glass substrate,
wherein the pattern layer is divided into a first region and a second region to implement the shaded portions, and
wherein the pattern layer is provided such that a difference in shade is realized between the first region and the second region.

10. The vehicle glass of claim 9, wherein the pattern layer is provided as a plurality of black enamels having a dot shape for a shade difference on the glass substrate and wherein adjusting printing intervals of the plurality of black enamels to realize the difference in shade between the first region and the second region.

11. The vehicle glass of claim 10, wherein the pattern layer is provided so that dot intervals of the plurality of black enamels in the first region are wider than dot intervals of the plurality of black enamels in the second region, whereby the first region is implemented in a relatively brighter shade than the second region.

12. The vehicle glass of claim 9, wherein the metallic coating layer is a translucent metallic coating layer made from any one of chromium (Cr), aluminum (Al), copper (Cu), nickel (Ni), silver (Ag), gold (Au), palladium (Pd), or any combination thereof.

13. The vehicle glass of claim 9, further comprising:
a non-metallic protective layer protecting the metallic coating layer,
wherein the non-metallic protective layer is stacked on the metallic coating layer including the pattern layer in a state in which the pattern layer is printed on the metallic coating layer.

14. The vehicle glass of claim 9, further comprising:
a non-metallic protective layer protecting the metallic coating layer,
wherein the pattern layer is printed on the non-metallic protective layer in a state in which the non-metallic protective layer is stacked on the metallic coating layer.
